(19) United States
(12) Patent Application Publication
(10) Pub. No.: US 2025/0240558 A1
(43) Pub. Date: Jul. 24, 2025

(54) VIBRATION DAMPING LOUDSPEAKER

(71) Applicant: FORTUNE GRAND TECHNOLOGY INC., Taoyuan City (TW)

(72) Inventors: PING-YU LEE, Taoyuan City (TW); JIAN LV, Taoyuan City (TW); CHUAN HE, Taoyuan City (TW); HONG-SHENG ZHANG, Taoyuan City (TW); YU-HSI CHEN, Taoyuan City (TW)

(73) Assignee: FORTUNE GRAND TECHNOLOGY INC., Taoyuan City (TW)

(21) Appl. No.: 18/923,710

(22) Filed: Oct. 23, 2024

(30) Foreign Application Priority Data
Jan. 23, 2024 (CN) 202410098418.4
Feb. 2, 2024 (TW) 113104262

(51) Int. Cl. H04R 1/28

(52) U.S. Cl. CPC H04R 1/2803

(57) ABSTRACT

A vibration damping loudspeaker includes a sound generating unit, a magnetic assembly, a connecting member and a damping member. The connecting member is symmetrically arranged at the sound generating unit. The damping member is symmetrically injection molded between the magnetic assembly and the connecting member. A main magnetic plate is not in direct contact with the connecting member and thus a distance is formed in between. Thus, in the vibration damping loudspeaker of the present disclosure, by securely coupling the connecting member to the sound generating unit and securely assembling the damping member between the connecting member and the magnetic assembly, the damping member forms a buffer between the sound generating unit and the magnetic assembly, so as to achieve effects of shock absorption and shock isolation during the operation of the vibration damping loudspeaker to prevent discomfort of a user during use of an electronic device.

### CROSS-REFERENCE TO RELATED APPLICATION

This non-provisional application claims priority under 35 U.S.C. § 119(a) on Patent Application No(s). 202410098418.4 filed in China on Jan. 23, 2024, and Patent Application No(s). 113104262 filed in Taiwan, R.O.C. on Feb. 2, 2024, the entire contents of which are hereby incorporated by reference.

### BACKGROUND OF THE INVENTION

### 1. Field of the Invention

The present disclosure relates to a vibration damping loudspeaker, and in particular to a vibration damping loudspeaker capable of achieving effects of shock absorption and shock isolation during the operation of the vibration damping loudspeaker to prevent discomfort of a user during use of an electronic device.

### 2. Description of the Related Art

In a current common loudspeaker, a magnetic assembly thereof is usually a single magnetic structure and is fixedly assembled to a speaker base of the loudspeaker. Due to the lack of a design for buffering between the speaker base and the magnetic assembly, the vibration of the loudspeaker during the operation of the loudspeaker is directly transmitted to a casing of an electronic device in which the loudspeaker is installed, resulting in discomfort of a user during use of the electronic device.

Therefore, the present disclosure aims to disclose a vibration damping loudspeaker in order to achieve effects of shock absorption and shock isolation during the operation of the vibration damping loudspeaker, so as to prevent discomfort of a user during use of an electronic device.

### BRIEF SUMMARY OF THE INVENTION

In view of the above drawbacks of the prior art, with extensive research and development to overcome the drawbacks, the applicant provides a vibration damping loudspeaker, which, by securely coupling a connecting member to a sound generating unit and securely assembling a damping member between the connecting member and a magnetic assembly such that the damping member forms a buffer between the sound generating unit and the magnetic assembly, achieves effects of shock absorption and shock isolation during the operation of the vibration damping loudspeaker to prevent discomfort of a user during use of an electronic device.

To achieve the above and other objects, the present disclosure provides a vibration damping loudspeaker, which includes a sound generating unit, a magnetic assembly, a plurality of connecting members and a plurality of damping members. The sound generating unit includes a speaker base, a vibration diaphragm and a voice coil. The vibration diaphragm is disposed at the speaker base, and the voice coil is connected to the vibration diaphragm. The magnetic assembly includes a main magnetic plate and a magnetic unit, wherein the magnetic unit is disposed at the main magnetic plate, and the voice coil is movably arranged outside the magnetic unit. The connecting members are respectively symmetrically arranged on two sides of the speaker base. The damping members are respectively symmetrically injection molded between the main magnetic plate and the connecting members. The main magnetic plate is not in direct contact with the connecting members and thus a distance is formed in between.

In the above vibration damping loudspeaker, each of two symmetrical sides of the speaker base is provided with two assembly portions, and each of two sides of each connecting member is provided with a counterpart assembly portion, and the counterpart assembly portions are assembled with the assembly portions, respectively.

In the above vibration damping loudspeaker, each of two symmetrical sides of the main magnetic plate is provided with an insert portion, one side of each of the damping members is provided with a connecting portion, and the connecting portions are injection molded at the insert portions, respectively.

In the above vibration damping loudspeaker, each of the insert portions is provided with a notch and a panel portion adjacent to each other, and the connecting portion of each of the damping members is injection molded at and envelops the notch and the panel portion.

In the above vibration damping loudspeaker, each of the insert portions is provided with at least one through hole, each of the connecting portions is provided with at least one connecting rod therein, and the connecting rod is injection molded at the through hole.

In the above vibration damping loudspeaker, one side of each of the connecting members is provided with at least one first limiting groove, one other side of each of the connecting members is provided with two extension portions, a second limiting groove is formed between the extension portions, one other side of each of the damping members is provided with at least one limiting protrusion and a scarfing portion, the limiting protrusion is injection molded at the first limiting groove, the scarfing portions are respectively injection molded at the second limiting grooves, and the extension portions are respectively located on outer sides of the scarfing portions.

In the above vibration damping loudspeaker, each of the damping members is provided with a step abutment portion, the step abutment portions are respectively located over the scarfing portions, and the step abutment portions press against the connecting members, respectively.

In the above vibration damping loudspeaker, each of the step abutment portions is provided with a sloped surface.

In the above vibration damping loudspeaker, each of the damping members is provided with a planar enveloping portion, the planar enveloping portions are located over the limiting protrusions and the scarfing portions, respectively, and the planar enveloping portions are injection molded at and envelop the connecting members, respectively.

In the above vibration damping loudspeaker, a hardness of the damping members is between 50 degrees and 70 degrees.

In the above vibration damping loudspeaker, the distance between the main magnetic plate and the connecting members is U-shaped.

In the above vibration damping loudspeaker, the connecting members are made of a plastic or metal material.

In the above vibration damping loudspeaker, the connecting members are made of a carbon steel or alloy steel material.

In the above vibration damping loudspeaker, each of two symmetrical short sides of the speaker base may be provided with a block wall, each of two sides of each of the damping members is provided with a notch, two sides of each of the connecting members extend out of the notches, respectively, and an adhesion portion is provided between each of the connecting members and each of the block walls.

In the above vibration damping loudspeaker, each of two symmetrical sides of the main magnetic plate is provided with an insert portion, each of the insert portions is provided with at least one through hole, one side of each of the damping members is provided with a connecting portion, one other side of each of the damping members is provided with an enveloping portion, the enveloping portions are injection molded at the insert portions and the connecting members, respectively, and connecting rods for respectively scarfing with the through holes are formed on inner sides of the enveloping portions, respectively.

In the above vibration damping loudspeaker, each of two symmetrical sides of the speaker base is provided with a block wall arranged adjacent to each of the connecting members.

In the above vibration damping loudspeaker, each of two symmetrical sides of each of the damping members is provided with a notch, and two symmetrical sides of each of the connecting members extend out of the notches, respectively, so as to install the connecting members on the two symmetrical sides of the speaker base, respectively.

Thus, in the vibration damping loudspeaker of the present disclosure, by securely coupling the connecting member to the sound generating unit and securely assembling the damping member between the connecting member and the magnetic assembly, the damping member forms a buffer between the sound generating unit and the magnetic assembly, so as to achieve effects of shock absorption and shock isolation during the operation of the vibration damping loudspeaker to prevent discomfort of a user during use of an electronic device.

### BRIEF DESCRIPTION OF THE DRAWINGS

FIG. 1 is a first perspective schematic diagram of a vibration damping loudspeaker according to a first embodiment of the present disclosure.

FIG. 2 is a second perspective schematic diagram of a vibration damping loudspeaker according to the first embodiment of the present disclosure.

FIG. 3 is a bottom schematic diagram of a vibration damping loudspeaker according to the first embodiment of the present disclosure.

FIG. 4 is a first exploded schematic diagram of a vibration damping loudspeaker according to the first embodiment of the present disclosure.

FIG. 5 is a second exploded schematic diagram of a vibration damping loudspeaker according to the first embodiment of the present disclosure.

FIG. 6 is a third exploded schematic diagram of a vibration damping loudspeaker according to the first embodiment of the present disclosure.

FIG. 7 is a first cross-sectional schematic diagram of a vibration damping loudspeaker according to the first embodiment of the present disclosure.

FIG. 8 is a second cross-sectional schematic diagram of a vibration damping loudspeaker according to the first embodiment of the present disclosure.

FIG. 9 is a perspective schematic diagram of a vibration damping loudspeaker according to a second embodiment of the present disclosure.

FIG. 10 is a bottom schematic diagram of a vibration damping loudspeaker according to the second embodiment of the present disclosure.

FIG. 11 is a first exploded schematic diagram of a vibration damping loudspeaker according to the second embodiment of the present disclosure.

FIG. 12 is a second exploded schematic diagram of a vibration damping loudspeaker according to the second embodiment of the present disclosure.

FIG. 13 is a third exploded schematic diagram of a vibration damping loudspeaker according to the second embodiment of the present disclosure.

FIG. 14 is a first cross-sectional schematic diagram of a vibration damping loudspeaker according to the second embodiment of the present disclosure.

FIG. 15 is a second cross-sectional schematic diagram of a vibration damping loudspeaker according to the second embodiment of the present disclosure.

FIG. 16 is a first exploded schematic diagram of a vibration damping loudspeaker according to a third embodiment of the present disclosure.

FIG. 17 is a second exploded schematic diagram of a vibration damping loudspeaker according to the third embodiment of the present disclosure.

FIG. 18 is a third exploded schematic diagram of a vibration damping loudspeaker according to the third embodiment of the present disclosure.

FIG. 19 is a perspective schematic diagram of a vibration damping loudspeaker according to the third embodiment of the present disclosure.

FIG. 20 is a first cross-sectional schematic diagram of a vibration damping loudspeaker according to the third embodiment of the present disclosure.

FIG. 21 is a second cross-sectional schematic diagram of a vibration damping loudspeaker according to the third embodiment of the present disclosure.

### DETAILED DESCRIPTION OF THE INVENTION

To facilitate understanding of the object, characteristics and effects of the present disclosure, embodiments together with the attached drawings for the detailed description of the present disclosure are provided below.

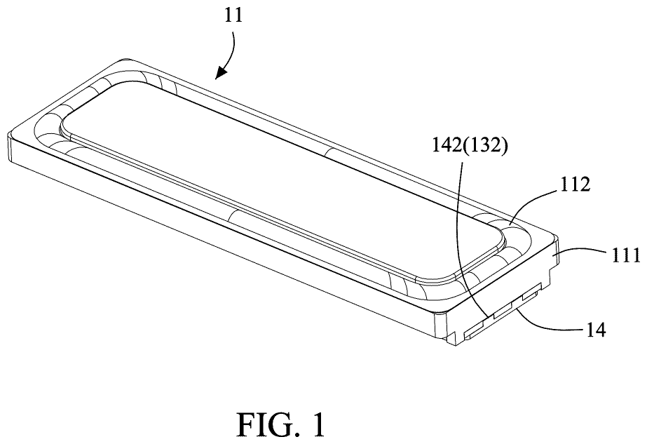

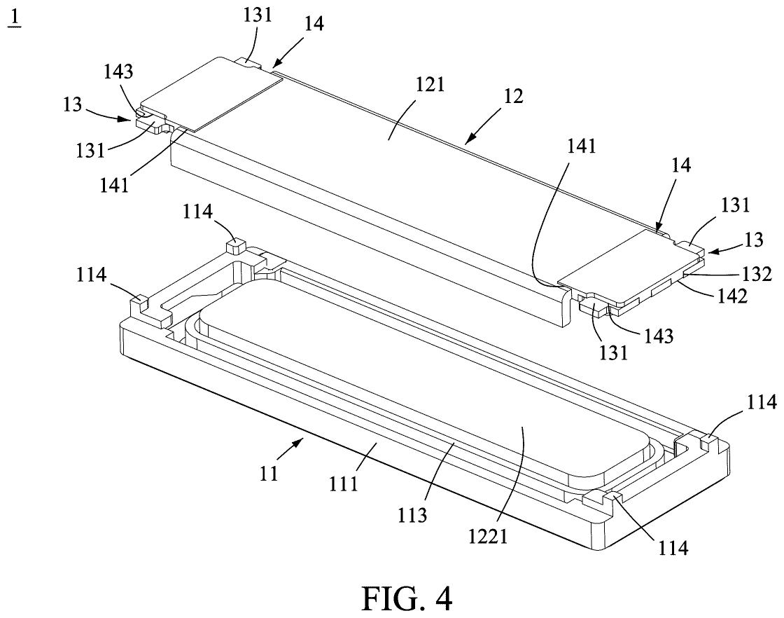

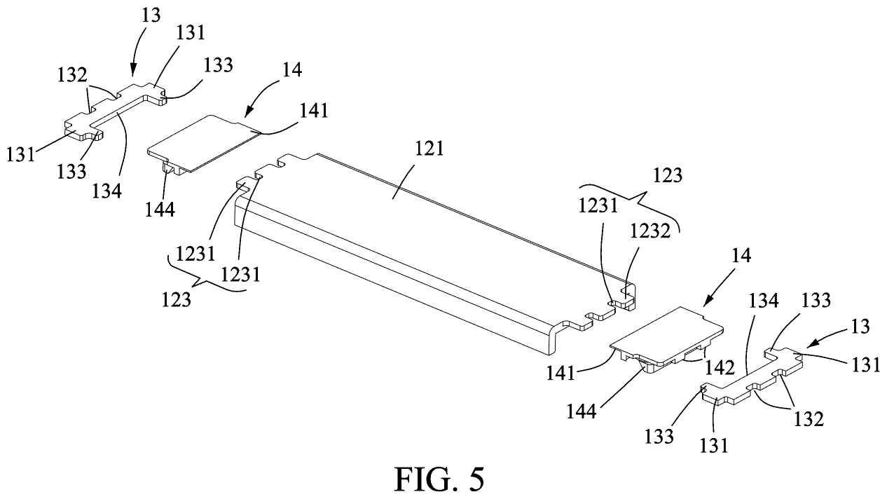

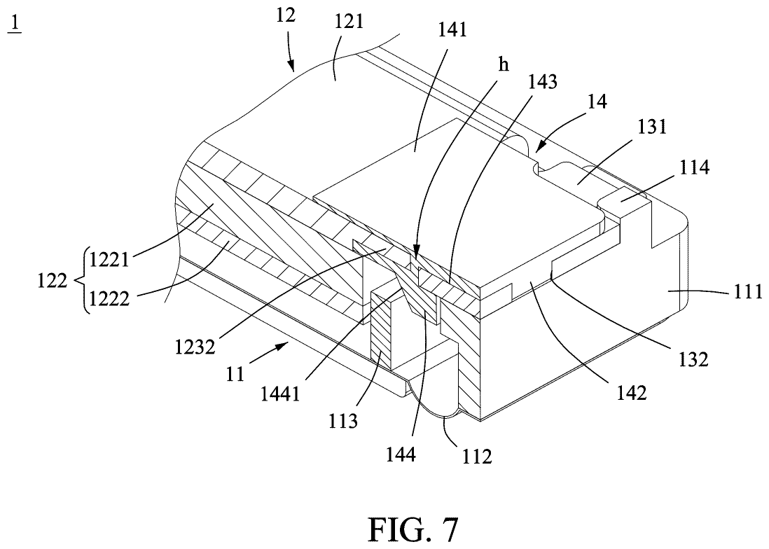

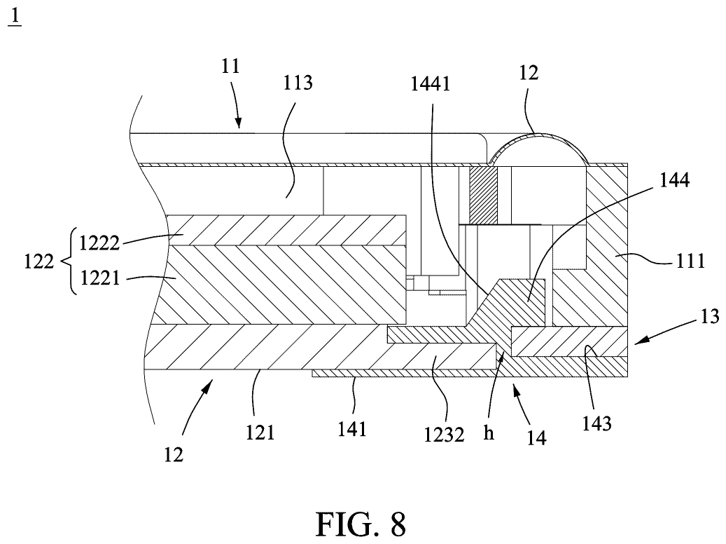

Referring to FIG. 1 to FIG. 8, as shown in the drawings, a vibration damping loudspeaker 1 is provided according to a first embodiment of the present disclosure. The vibration damping loudspeaker 1 includes a sound generating unit 11, a magnetic assembly 12, a plurality of connecting members 13 and a plurality of damping members 14. Each of the sound generating unit 11 and the magnetic assembly 12 may be shaped as a rectangle or a square, and a set of two symmetrical side portions of the rectangle or the square may each be shaped as arcs. Moreover, the connecting members 13 may be made of a material having high rigidity, for example, plastic or metal. If the connecting members 13 are made of metal material, the connecting members 13 may be made of a carbon steel or alloy steel material and are exemplified by a carbon steel material in the present disclosure.

The sound generating unit 11 includes a speaker base 111, a vibration diaphragm 112 and a voice coil 113. The vibration diaphragm 112 is disposed on a top of the speaker base 111, and the voice coil 113 is connected to a bottom of the vibration diaphragm 112.

The magnetic assembly 12 includes a main magnetic plate 121 and a magnetic unit 122, wherein a cross section of the main magnetic plate 121 may be U-shaped. The magnetic unit 122 is disposed on a top surface of a bottom of the main magnetic plate 121, and the voice coil 113 is movably arranged outside the magnetic unit 122 and between the main magnetic plate 121 and the magnetic unit 122. The magnetic unit 122 may be provided with a magnet 1221 and a magnetic plate 1222 stacked up on each other.

The connecting members 13 are symmetrically arranged on bottoms of two short sides of the speaker base 111 and correspond to the main magnetic plate 121. In one embodiment of the present disclosure, the number of the connecting members 13 may be two.

The damping members 14 are symmetrically injection molded between the main magnetic plate 121 and the connecting members 13. The main magnetic plate 121 is not in direct contact with the connecting members 13 and thus a distance h is formed in between. One side of each of the damping members 14 is coupled to two short sides of the main magnetic plate 121, and one other side of each of the damping members 14 is coupled to the connecting members 13. In one embodiment of the present disclosure, the number of the damping members 14 may be two, and the damping members 14 can be made of a material such as rubber or silicone.

To assemble the vibration damping loudspeaker 1, the damping members 14 may be symmetrically injection molded between the main magnetic plate 121 of the magnetic assembly 12 and the connecting members 13, and then be securely coupled to the speaker base 111 of the sound generating unit 11 by the connecting members 13, further securely assembling the damping members 14 between the sound generating unit 11 and the magnetic assembly 12. To put to use, the vibration damping loudspeaker 1 may be coupled to an acoustic enclosure (not shown). When the voice coil 113 of the sound generating unit 11 receives an externally input electronic signal, magnetic energy is provided by the main magnetic plate 121 with coordination of the magnetic unit 122 of the magnetic assembly 12, such that the voice coil 113 in coordination with the electromagnetic effect of the magnetic assembly 12 pushes the vibration diaphragm 112 to act, further enabling the vibration damping loudspeaker 1 to generate a sound.

In one embodiment of the present disclosure, the connecting members 13 may be attached with a larger area to the speaker base 111. Thus, the vibration damping loudspeaker 1 is able to ensure the binding strength between the connecting members 13 and the speaker base 111, so as to prevent the magnetic assembly 12 from falling off the speaker base 111 when the vibration damping loudspeaker 1 is dropped.

During the above operation of the vibration damping loudspeaker 1, with the damping members 14 provided, the speaker base 111 of the sound generating unit 11 is not in direct contact with the magnetic assembly 12, and so the damping members 14 can be used as a buffer between the speaker base 111 and the magnetic assembly 12 to absorb (deplete) kinetic energy generated during vibration of the sound generating unit 11 and prevent returning of kinetic energy generated during vibration of the magnetic assembly 12, thereby achieving effects of shock absorption and shock isolation during the operation of the vibration damping loudspeaker 1 and further preventing discomfort of a user during use of an electronic device. Moreover, by using the damping members 14 as the buffer between the speaker base 111 and the magnetic assembly 12, the vibration frequency of the magnetic assembly 12 may be approximate to but have an opposite phase from the vibration frequency of the speaker base 111, further achieving an effect of shock absorption.

In addition, with the damping members 14 disposed between the sound generating unit 11 and the magnetic assembly 12, the magnetic assembly 12 is suspended by the damping members 14 and is elastic. A resonant frequency can be obtained by adjusting the weight of the magnetic assembly 12 and the elastic coefficient of the damping members 14. When the resonant frequency approximates to the vibration frequency of the sound generating unit 11, kinetic energy of vibrations of the two may be counteracted to achieve an effect of shock absorption.

Moreover, in the vibration damping loudspeaker 1 of the present disclosure, the distance h is present between the connecting members 13 and the main magnetic plate 121 of the magnetic assembly 12, and the damping members 14 are used as a filler for the distance h, so as to better deplete kinetic energy generated from vibration.

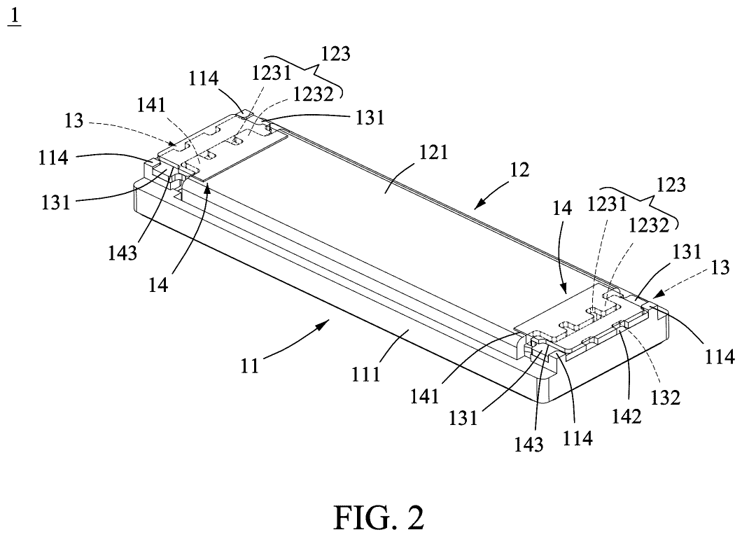

Referring to FIG. 2 to FIG. 4 and FIG. 7, as shown in the drawings, in addition to the embodiments above, in one embodiment of the present disclosure, each of two symmetrical short sides of the speaker base 111 is provided with two assembly portions 114 (for example, protrusions), and each of two sides of each of the connecting members 13 may be provided with a counterpart assembly portion 131 (for example, an end groove formed by a flange), and the counterpart assembly portions 131 are assembled with the assembly portions 114, respectively. Thus, the present disclosure is capable of quickly positioning the connecting members 13 between the assembly portions 114 and achieving an effect of quick and simple assembly so as to improve a yield rate.

Referring to FIG. 2 to FIG. 8, as shown in the drawings, in addition to the embodiments above, in one embodiment of the present disclosure, each of two symmetrical short sides of the main magnetic plate 121 may be provided with an insert portion 123, one side of each of the damping members 14 may be provided with a connecting portion 141, and the connecting portions 141 are injection molded at the insert portions 123, respectively. Moreover, each of the insert portions 123 may be provided with a notch 1231 and a panel portion 1232 adjacent to each other, and the connecting portion 141 of each of the damping members 14 is injection molded at and envelops the notch 1231 and the panel portion 1232. Thus, once the damping members 14 of the present disclosure are injection molded, the material of the damping members 14 is scarfed with the notch 1231 and the panel portion 1232 to form the connecting portions 141, such that the damping members 14 are injection molded and securely envelop the insert portions 123 by the connecting portions 141, further enabling the injection molded damping members 14 to be securely coupled to two short sides of the main magnetic plate 121.

Referring to FIG. 2 to FIG. 6, as shown in the drawings, in addition to the embodiments above, in one embodiment of the present disclosure, one side of each of the connecting members 13 may be provided with at least one first limiting groove 132, one other side of each of the connecting members 13 may be provided with two corresponding extension portions 133, a second limiting groove 132 may be formed between the extension portions 133, one other side of each of the damping members 14 may be provided with at least one limiting protrusion 142 and a scarfing portion 143, the limiting protrusion 142 is injection molded at the first limiting groove 132, the scarfing portions 143 are respectively injection molded at the second limiting grooves 134, and the extension portions 133 are respectively located on outer sides of the scarfing portions 143. Thus, once the damping members 14 of the present disclosure are injection molded, the material of the damping members 14 is scarfed with the first limiting grooves 132 to form the limiting protrusions 142; meanwhile, the material of the damping members 14 is scarfed with the second limiting grooves 134 to form the scarfing portions 143, and the extension portions 133 are respectively located on the outer sides of the scarfing portions 143 to form a supported and sandwiched state, further securely coupling the injection molded damping members 14 to the connecting members 13 with coordination of the first limiting grooves 132, the extension portions 133 and the second limiting grooves 134.

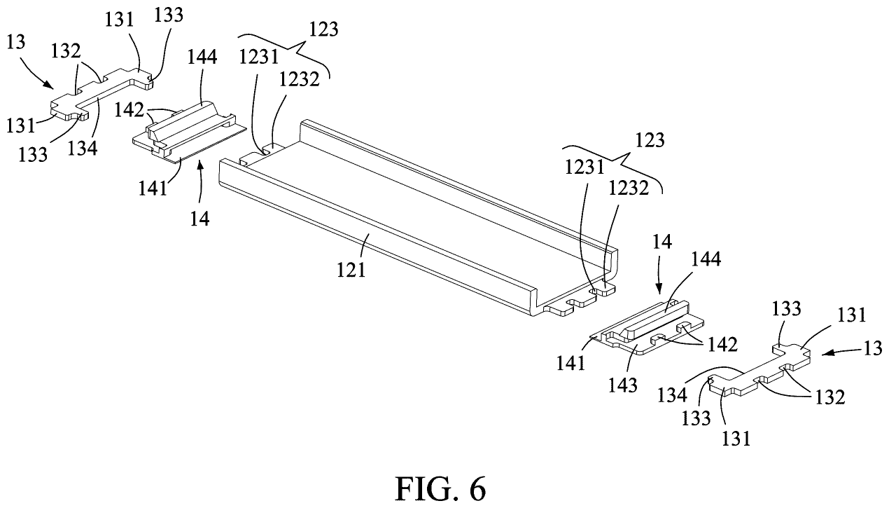

Referring to FIG. 6 to FIG. 8, as shown in the drawings, in addition to the embodiments above, in one embodiment of the present disclosure, each of the damping members 14 may be provided with a step abutment portion 144. The step abutment portions 144 are respectively located over the scarfing portions 143, and each of the step abutment portions 144 presses against a portion of each of the connecting members 13. Thus, in the present disclosure, the injection molded damping members 14 can envelop the connecting members 13 with a better area, so as to reinforce the binding strength between the damping members 14 and the connecting members 13.

Moreover, the damping members 14 can also adjust the thickness thereof by using the step abutment portions 144; the hardness of the damping members 14 increases as the step abutment portions 144 get thicker (higher), so as to change the resonant frequency of the vibration damping loudspeaker 1.

In addition, each of the step abutment portions 144 may be provided with a sloped surface 1441. In addition to preventing the voice coil 113 from collision, the sloped surfaces 1441 can also at the same time increase the strength of enveloping the connecting members 13 by the damping members 14.

In addition to the embodiments above, in one embodiment of the present disclosure, the hardness of the damping members 14 may be between 50 degrees and 70 degrees, and the damping effect accomplished by the damping members 14 improves as the damping members 14 get softer. Moreover, the elastic coefficient of the damping members 14 may be adjusted according to the hardness, thickness or shape of a material.

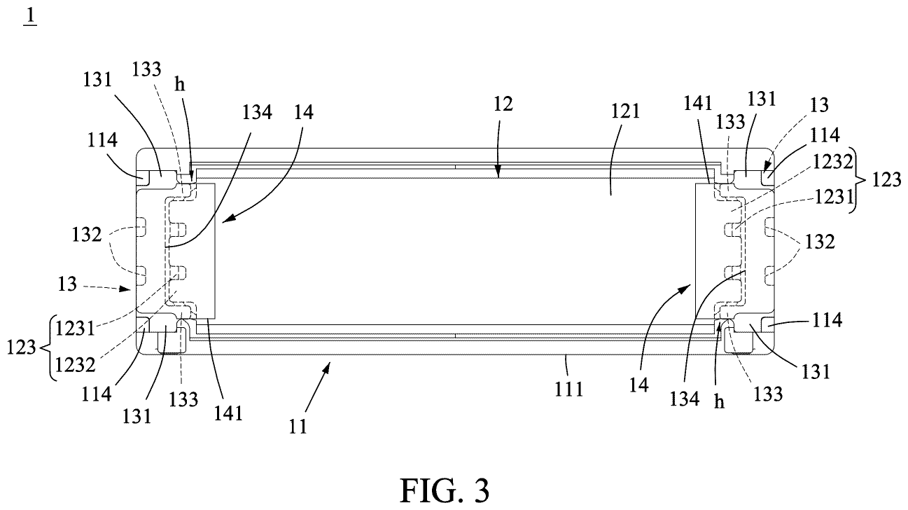

Referring to FIG. 2 and FIG. 3, as shown in the drawings, in addition to the embodiments above, in one embodiment of the present disclosure, the distance h between the main magnetic plate 121 and the connecting members 13 may be U-shaped. Thus, due to limitations such as space in a way that the distance h is smaller and kinetic energy of vibration cannot be easily depleted, the distance h is U-shaped so as to increase the contact area of the damping members 14 and to enhance a passive shock-absorption effect of the vibration damping loudspeaker 1.

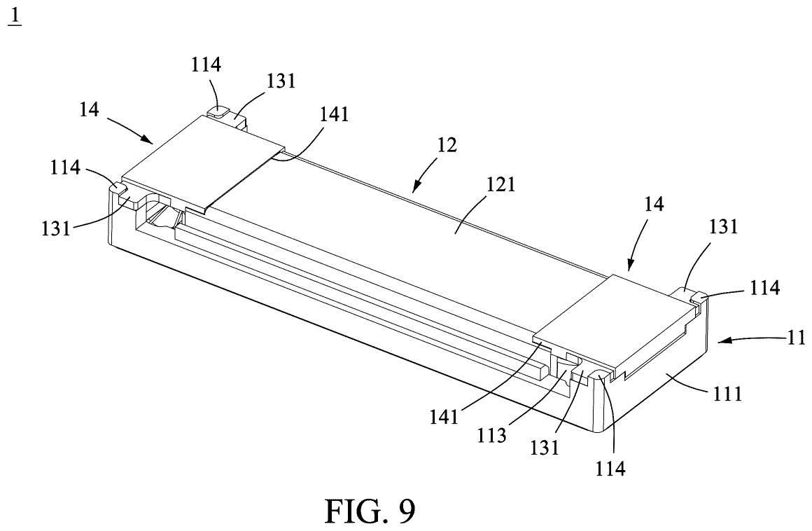

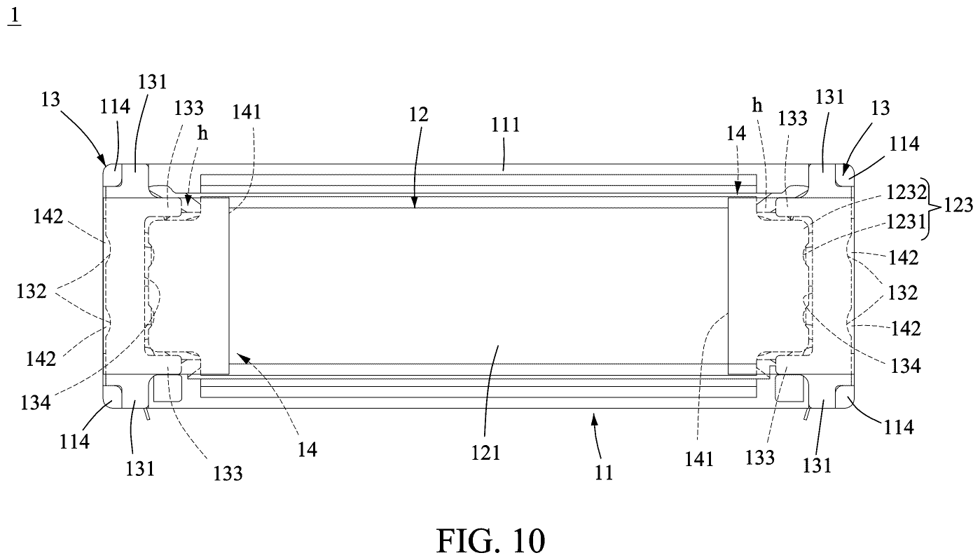

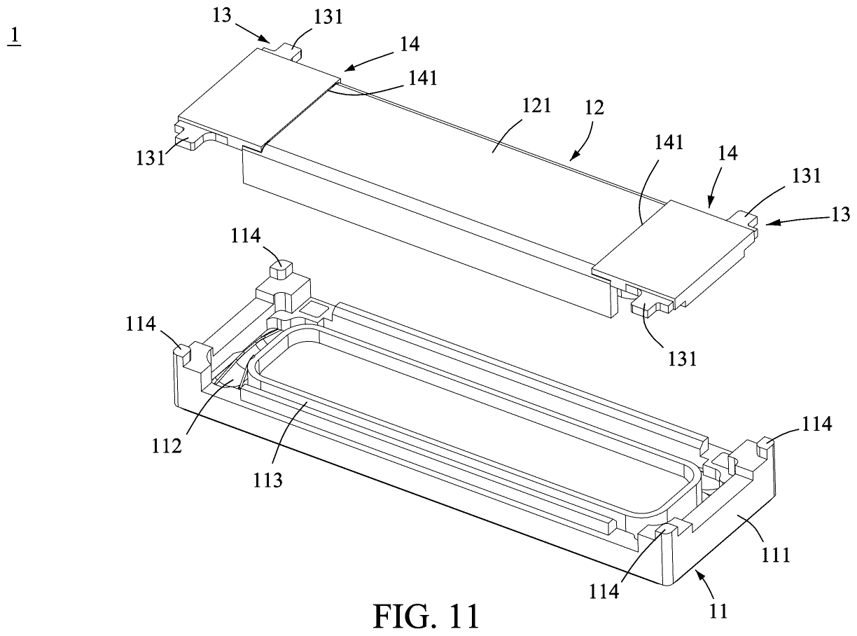

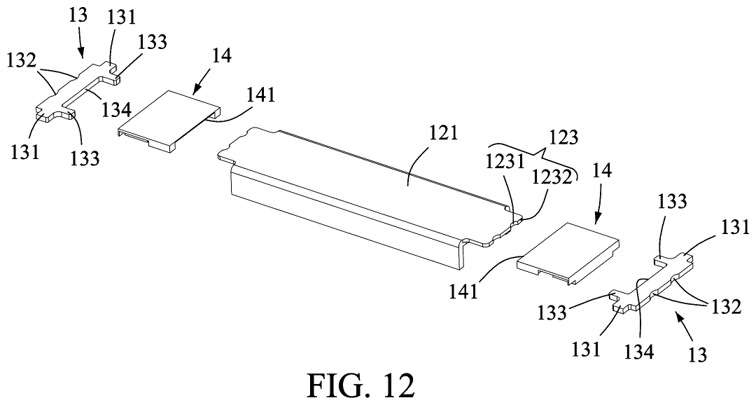

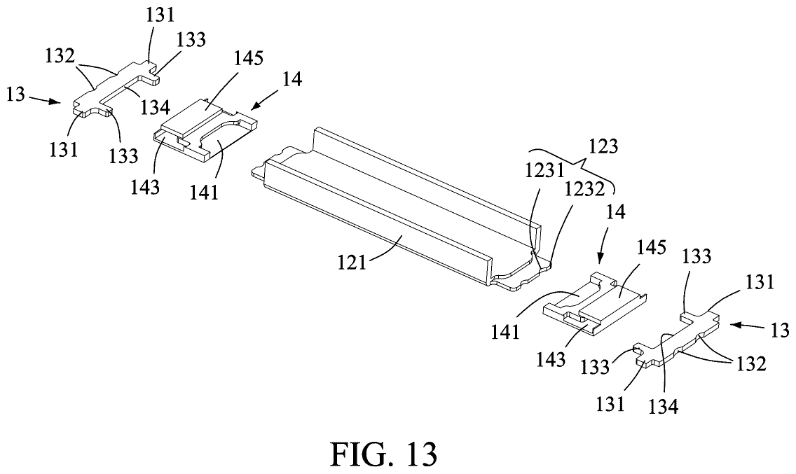

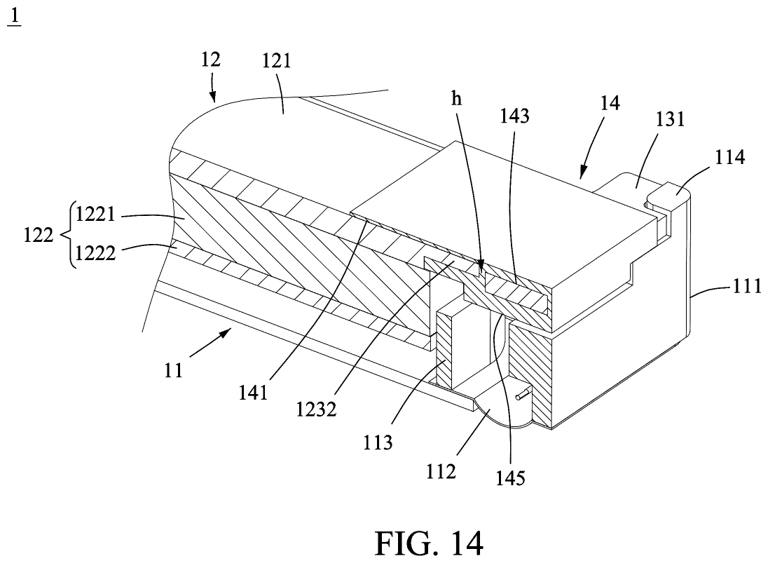

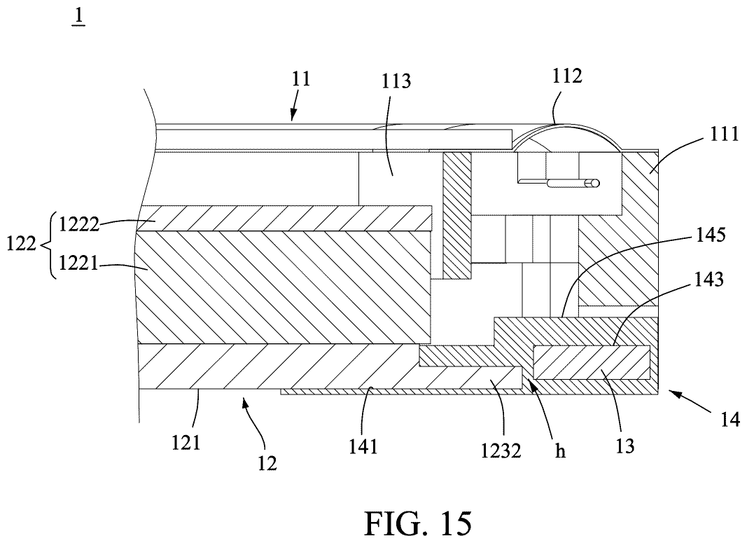

Referring to FIG. 9 to FIG. 15, as shown in the drawings, in addition to the embodiments above, in a second embodiment of the present disclosure, each of the damping members 14 may be alternatively provided with a planar enveloping portion 145. The planar enveloping portions 145 are respectively located over the limiting protrusions 142 and the scarfing portions 143, and are respectively injection molded at and envelop the connecting members 13. Thus, when the damping members 14 are made of a material having a larger hardness selected (or when the hardness does not need to be too high) due to actual application requirements, the planar enveloping portions 145 may be respectively injection molded and envelop the part between two sides of the connecting members 13 to leave only the two sides of the connecting members 13 to be attached (adhered) to the speaker base 111, hence similarly increasing the binding strength between the damping members 14 and the connecting members 13 and changing the resonant frequency of the vibration damping loudspeaker 1.

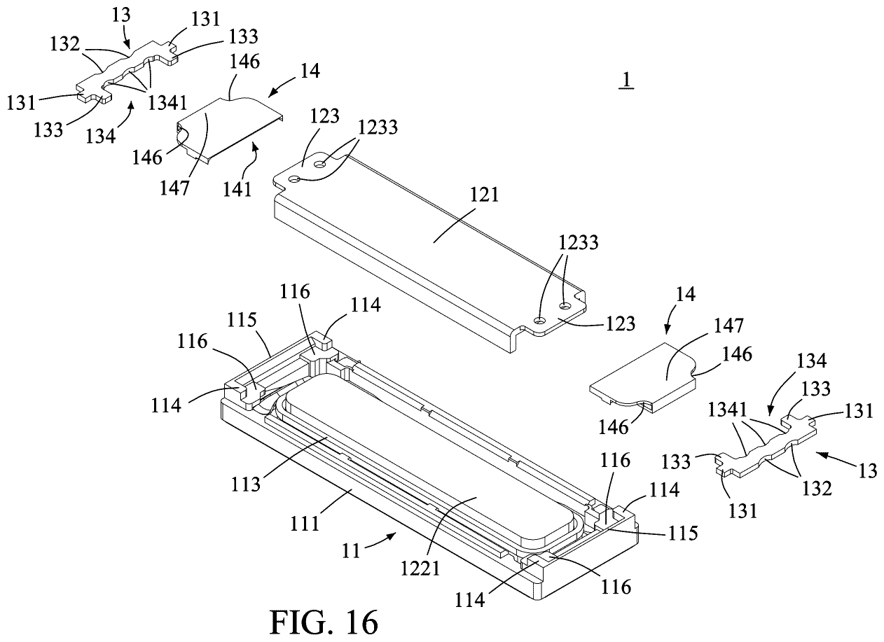

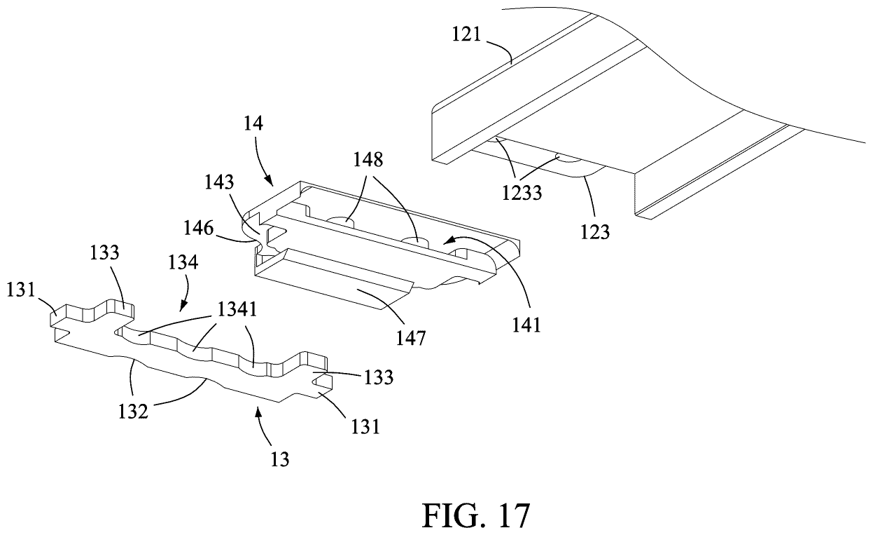

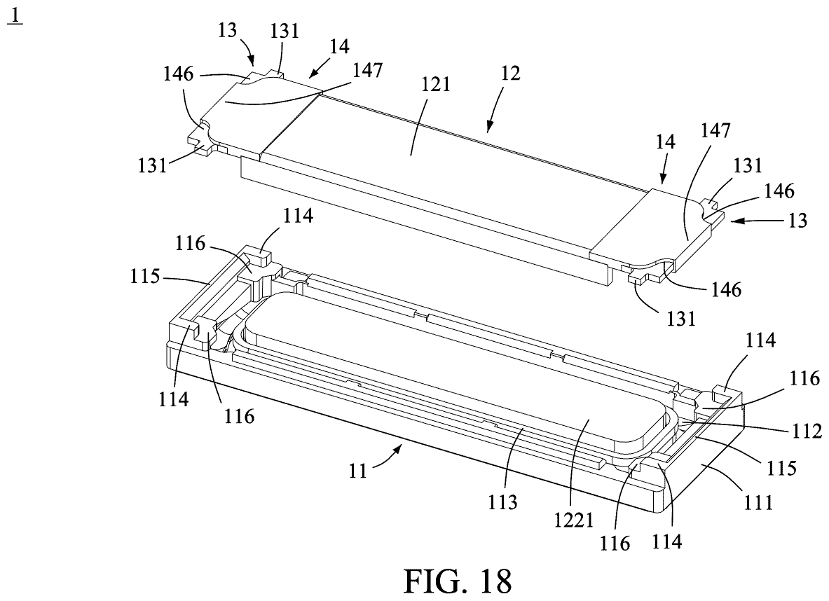

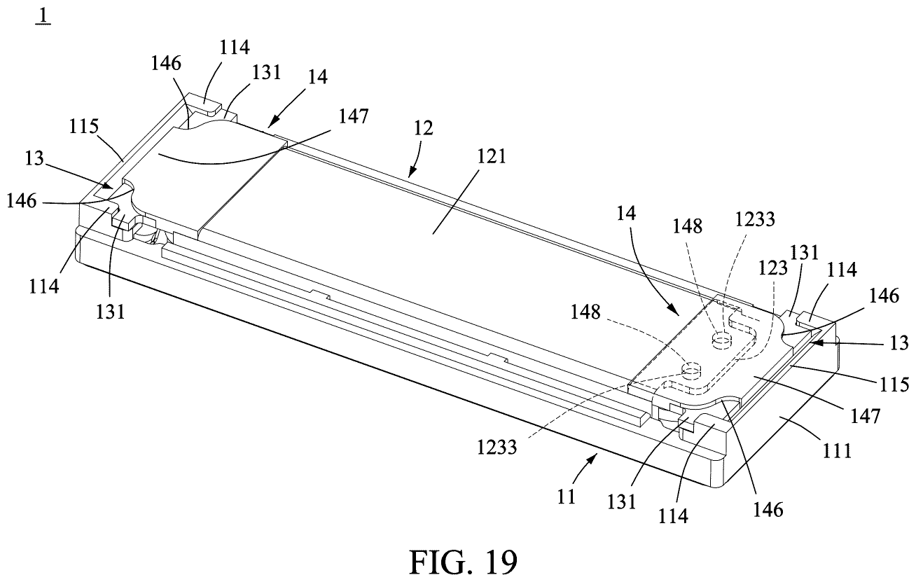

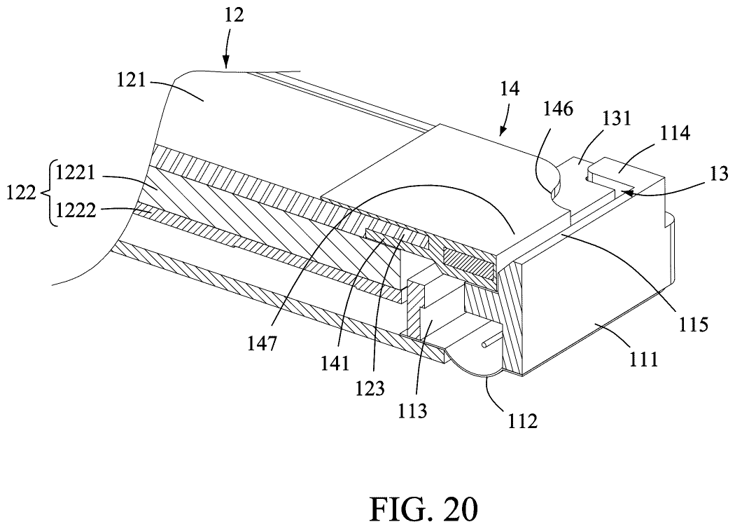

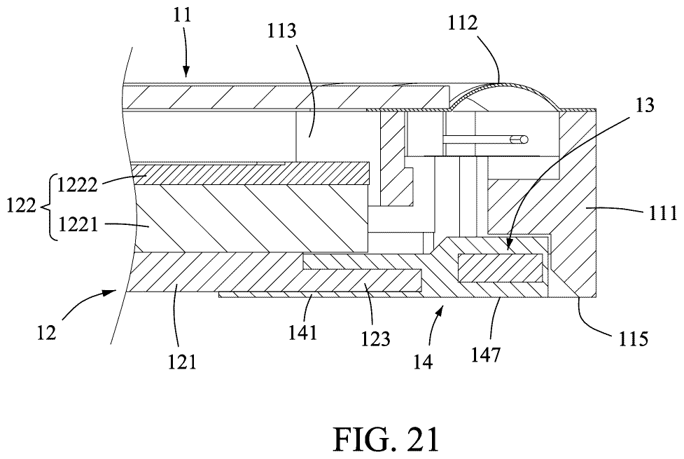

Referring to FIG. 16 to FIG. 21, as shown in the drawings, in addition to the embodiments above, in a third embodiment of the present disclosure, each of two symmetrical short sides of the speaker base 111 may be provided with a block wall 115 arranged adjacent to the connecting members 13 and the damping members 14, and the block walls 115 may be adjacently connected between the assembly portions 114 on each of the short sides of the speaker base 111. Moreover, each of two symmetrical sides of each of the damping members 14 may be provided with a notch 146, and the counterpart assembly portions 131 on the two symmetrical sides of each of the connecting members 13 may extend out of the notches 146, respectively, so as to be adhered by an adhesive to two adhesion portions 116 on each of the short sides of the speaker base 111 and each of the block walls 115. Thus, the notches 146 of each of the damping members 14 can increase an exposed area of the counterpart assembly portions 131 of each of the connecting members 13, so as to be correspondingly adhered to the adhesion portions 116 with increased areas. In addition, the block walls 115 can provide greater adhesion areas for adhering the connecting members 13, respectively. Thus, once the counterpart assembly portions 131 of the connecting members 13 are adhered to the adhesion portions 116 of the speaker base 111, respectively, an adhesive may be injected into respective gaps between the connecting members 13 and the block walls 115 to further reinforce the binding strength between the connecting members 13 and the speaker base 111, further ensuring that the connecting members 13 do not fall off the speaker base 111. In addition, at least one limiting groove 1341 may be additionally provided in the second limiting groove 134 of each of the connecting members 13, so that the binding strength between the damping members 14 and the connecting members 13 can be reinforced when the enveloping portions 147 of the damping members 14 are injection molded at and envelop the connecting members 13, respectively.

In addition to the embodiments above, in one embodiment of the present disclosure, each of the two insert portions 123 on the two symmetrical short sides of the main magnetic plate 121 may be provided with at least one through hole 1233, each of the connecting portions 141 of the damping members 14 may be provided with at least one connecting rod 148 therein, and the connecting rod 148 may be injection molded at the through hole 1233. Thus, the binding strength between the damping members 14 and the main magnetic plate 121 can be reinforced when the damping members 14 are injection molded at and envelop the main magnetic plate 121.

The present disclosure is described by way of the preferred embodiments above. A person skilled in the art should understand that, the embodiments are merely for illustrating the present invention and are not to be construed as limitations to the scope of the present disclosure. It should be noted that all equivalent changes, replacements and substitutions made to the embodiments are encompassed within the scope of the present disclosure. Therefore, the legal protection for the present disclosure should be defined by the appended claims.

What is claimed is:

1. A vibration damping loudspeaker, comprising:
a sound generating unit, comprising a speaker base, a vibration diaphragm and a voice coil, the vibration diaphragm disposed on the speaker, and the voice coil connected to the vibration diaphragm;
a magnetic assembly, comprising a main magnetic plate and a magnetic unit, the magnetic unit disposed at the main magnetic plate, wherein the voice coil movably arranged outside the magnetic unit;
a plurality of connecting members, symmetrically arranged on two sides of the speaker base; and
a plurality of damping members, symmetrically injection molded between the main magnetic plate and the connecting members, wherein the main magnetic plate is not in direct contact with the connecting members and a distance is formed in between.

2. The vibration damping loudspeaker according to claim 1, wherein each of two symmetrical sides of the speaker base is provided with two assembly portions, and each of two sides of each of the connecting members is provided with a counterpart assembly portion, and the counterpart assembly portions are assembled with the assembly portions, respectively.

3. The vibration damping loudspeaker according to claim 1, wherein each of two symmetrical sides of the main magnetic plate is provided with an insert portion, one side of each of the damping members is provided with a connecting portion, and the connecting portions are injection molded at the insert portions, respectively.

4. The vibration damping loudspeaker according to claim 3, wherein each of the insert portions is provided with a notch and a panel portion adjacent to each other, and the connecting portion of each of the damping members is injection molded at and envelops the notch and the panel portion.

5. The vibration damping loudspeaker according to claim 3, wherein each of the insert portions is provided with at least one through hole, each of the connecting portions is provided with at least one connecting rod therein, and the connecting rod is injection molded at the through hole.

6. The vibration damping loudspeaker according to claim 1, wherein one side of each of the connecting members is provided with at least one first limiting groove, one other side of each of the connecting members is provided with two extension portions, a second limiting groove is formed between the extension portions, one other side of each of the damping members is provided with at least one limiting protrusion and a scarfing portion, the limiting protrusion is injection molded at the first limiting groove, the scarfing portions are respectively injection molded at the second limiting grooves, and the extension portions are respectively located on outer sides of the scarfing portions.

7. The vibration damping loudspeaker according to claim 6, wherein each of the damping members is provided with a step abutment portion, the step abutment portions are respectively located over the scarfing portions, and the step abutment portions press against the connecting members, respectively.

8. The vibration damping loudspeaker according to claim 7, wherein each of the step abutment portions is provided with a sloped surface.

9. The vibration damping loudspeaker according to claim 6, wherein each of the damping members is provided with a planar enveloping portion, the planar enveloping portions are located over the limiting protrusions and the scarfing portions, respectively, and the planar enveloping portions are injection molded at and envelop the connecting members, respectively.

10. The vibration damping loudspeaker according to claim 1, wherein a hardness of the damping members is between 50 degrees and 70 degrees.

11. The vibration damping loudspeaker according to claim 1, wherein the distance between the main magnetic plate and the connecting members is U-shaped.

12. The vibration damping loudspeaker according to claim 1, wherein the connecting members are made of a plastic or metal material.

13. The vibration damping loudspeaker according to claim 12, wherein the connecting members are made of a carbon steel or alloy steel material.

14. The vibration damping loudspeaker according to claim 1, wherein each of two symmetrical sides of the speaker base is provided with a block wall arranged adjacent to the connecting members.

15. The vibration damping loudspeaker according to claim 1, wherein each of two symmetrical sides of each of the damping members is provided with a notch, and each of two symmetrical sides of each of the connecting members extends out of each of the notches so as to install the connecting members on the two symmetrical sides of the speaker base.
